(19) United States
(12) Patent Application Publication
(10) Pub. No.: US 2006/0016294 A1
(43) Pub. Date: Jan. 26, 2006

(54) Temperature insulated beverage container receptacle and opening apparatus

(76) Inventors: Michael W. McGrath, Lakeside, CA (US); Michael Bilotta, Fallbrook, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/186,680

(22) Filed: Jul. 19, 2005

Related U.S. Application Data
(60) Provisional application No. 60/589,734, filed on Jul. 20, 2004.

(51) Int. Cl. B67B 7/44; F25D 3/08

(52) U.S. Cl. 81/3.09; 62/457.4; 81/3.15

(57) ABSTRACT

A beverage container receptacle and opening apparatus having a base adapted to support a beverage container and having one or a plurality of beverage container openers formed into the base. The openers provide a twist off bottle cap remover, a pry-off bottle cap remover, and a pull tab prying device. A sleeve rising from a top surface of the base provides an insulator as well as a component to hold the container to the base during movement.

### FIELD OF THE INVENTION

This application claims priority from U.S. provisional application Ser. No. 60/589,734, filed Jul. 20, 2004.

The present invention relates to the opening and insulated support of beverage containers. More particularly it relates to a device adapted to engage with the closures of two types of bottles and aluminum cans and to provide increased frictional engagement in the opening of those containers. Additionally, the device provides for support of any of the opened containers in a position insulated above a lower support surface and insulated from surrounding air which tends to warm cold drinks.

### BACKGROUND OF THE INVENTION

Since drinks were first prepared and sold there has been a need for beverage containers to hold the libations for consumption. Such containers have evolved to two primary types in use today which include bottles and aluminum “pop-top” cans.

In the case of bottles, two primary closures have developed over time to be used for sealing the interior cavity of the bottle to prevent leakage of the contained beverage and to prevent contamination of the beverage by germs and bacteria. Additionally, maintaining a seal on the closure is important to keep the contents of the bottle tasting fresh since oxygen contact with the beverage can have detrimental effects on taste. Further, many beverages are carbonated and maintaining a sealed closure of the bottle opening is paramount in keeping the beverage inside bubbly.

Most beverage bottles have a neck end which on the distal end provides a mount for a cap in sealed engagement over the sole aperture allowing access to the beverage in the bottle. Such caps have two primary forms. One type of cap is screwed onto the distal end of the bottle neck and the other type features a cap in a compressed sealed engagement on the bottle neck.

Removal of the screw type cap requires the user to frictionally engage the exterior of the cap and thereafter twist with sufficient torque to unscrew the cap. In many cases twist-on caps also have a base portion that is in a scored engagement to the cap. Removal requires sufficient torque to break the cap material along the scored area prior to unscrewing the cap.

To remove the compressedly engaged cap, an opening device is required which will lift one side edge of the engaged cap with sufficient force to pull it off the distal end of the bottle. The required force is reduced if the opening device provides a means to bend the top surface of the cap while the side edge is lifted.

In the case of cans, over the years they have evolved from a can having a top surface which requires a piercing tool to cans that currently include a pre-scored opening defined by scoring or etching a section in the top side surface of the can which is attached to a pull ring. Opening the can requires the user to pull on the ring with sufficient force to break the top of the can inside the scored section away from the rest of the top section. While pulling the ring with the finger inside of it is a fairly easy task, the act of first lifting the ring from a default position parallel to the top surface of the can to an angled engagement therewith can be a very difficult task for the very young, the very old, dexterity impaired persons, and people lacking fingernails. Even people with fingernails can have a hard time forcing the ring to an elevated position and women with long fingernails frequently scorn such cans when a nail is broken.

Attempts in the past at providing opener aids generally concentrated on individual openers for each individual type of bottle or can. Consequently, a user with all three types of containers would either be forced to use only their hands in the struggle to open the beverage containers, or to carry separate opening aids.

Still further, most such beverage containers whether they be bottles or cans have little insulation ability to keep their contents cold. Because many drinks such as beer and soda are preferred cold in the United States and in many foreign countries, this lack of insulating ability causes the contents of the bottle or can to heat more quickly, thus impairing the beverage. If the can or bottle is placed on a warm surface such as an outside table, the heat from the underlying surface by natural conduction enters the beverage in the bottle and prematurely warms it. Additionally, if the air surrounding the bottle or can is warmer than its contents as is frequently the case, the exterior surface of the bottle or can will transmit surrounding heat into the drink inside and shorten the cold drinking time of the user.

A number of insulating schemes have been arrived at in the past; however, none have provided a combination insulator and opener for multiple containers. Consequently, beverage consumers in the past have been required to carry both insulators and quite possibly multiple opening aids if they have a plurality of container types for their intended beverages.

Accordingly, there exists an unfilled need for a beverage opener that will concurrently serve as an insulator from the beverage support surface and surrounding air. Such a beverage opening device should provide users with increased frictional engagement and/or torque in removing the intended beverage container closure. Still further, it would be highly desirable if the device provided a plurality of different closure engaging components allowing the user to carry one device to open multiple types of beverage closure devices. Additionally, it would also be desirable if the device enhanced the removable engagement of a beverage container to the underlying surface.

With respect to the above description, before explaining at least one preferred embodiment of the invention in detail, it is to be understood that the invention is not limited in its application to the details of construction and to the arrangement of the components or steps set forth in the following description or illustrated in the drawings, nor just to beverage containers. The various apparatuses and methods of the invention are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other devices, methods and systems for carrying out the several purposes of the present disclosed device. It is important, therefore, that the objects and claims be regarded as including such equivalent construction and methodology insofar as they do not depart from the spirit and scope of the present invention.

Further objectives of this invention will be brought out in the following part of the specification, wherein detailed description is for the purpose of fully disclosing the invention without placing limitations thereon.

### SUMMARY OF THE INVENTION

The device herein described and disclosed provides users with an easily gripped and maneuvered beverage opening aid. The device in its simplest form provides at least one means of engagement with increased mechanical advantage to at least one beverage container closure. Ideally, the device provides a plurality of means for engagement to a plurality of respective beverage closures while concurrently providing increased mechanical advantage in the form of frictional engagement and torque or leverage from that which would be available if the consumer used his hand.

In addition to providing one or a plurality of different means for engagement and opening of beverage container bottle caps and pull tab closures the device provides means for insulation from the support surface on which the beverage container sits and means for insulation from the surrounding atmosphere. In a favored embodiment wherein a sleeve engages the exterior of the beverage container, the addition of an optional means for removable engagement with the underlying surface helps provide a stable mount for the beverage container left in the device. This can be an especially attractive characteristic when drinking from such containers in moving vehicles and boats.

A basic mode of the device features a base having a top side adapted to provide a support for the beverage container above and spaced from the underlying surface. Formed on a bottom surface is at least one and preferably a plurality of beverage closure openers from a group of such closure openers including a pull tap lifting component, bottle cap twisting component, and a bottle cap lifting component.

The perimeter edge of the base would be knurled or otherwise surfaced as a means to enhance frictional engagement of a hand gripping that surface such that when the bottle cap twisting component is present, increased torque is provided by the larger circumference of the perimeter, and slippage of the hand on that surface is prevented or inhibited.

The group of beverage closure openers which can be provided individually or in a plurality as noted includes a pull tap lifting component, bottle cap twisting component, and a bottle cap lifting component.

The pull tab lifting component is provided by a ledge formed on the circumference of the base. The ledge in the current preferred mode of the device is formed by a projection from the base of a thickness adapted to easily slide under a pull tab. The ledge is best if tapered from a thinner leading edge to a thicker rear edge. Thereafter the base is pulled upward from the edge opposite the ledge and the pull tab is forced to an upward angle.

The bottle cap twisting component is provided by a first cavity formed into the bottom surface of the body. The cavity has a top surface and a side surface with a diameter adapted to frictionally engage around the perimeter edge of a twist off bottle cap. Corrugating or otherwise surfacing the side surface to a shape essentially the negative of a conventional corrugated twist-off bottle cap provides means for mechanical engagement of the perimeter edge to a twist-off bottle cap inserted in the first cavity. Thereafter the user can easily twist off the cap due to the increased torque provided by the diameter of the base being larger than the diameter of the bottle cap.

The bottle cap lifting component disengagement of compressedly engaged bottle caps is provided by a second cavity formed into the bottom surface of the base. The second cavity has a diameter adapted to engage closely around a portion of the exterior edge of a non-twist compressedly engaged bottle cap. On one portion of the side edge a ledge overhangs a sufficient distance to slide under the bottom of a non-twist bottle cap inserted into the second cavity. Thereafter, much like the pull tab, the bottle cap may be removed by lifting the opposite side of the base from the side in which the ledge is positioned in the second cavity. A vertical fulcrum projects from the bottom surface of the second cavity a distance from the side edge from where the ledge projects, to place it in a center portion of an inserted cap. When the ledge is thereafter lifted by lifting the base, the fulcrum helps bend the cap in the middle allowing for an easier break of the seal of the cap to the bottle.

As noted, one mode of the device features an upper surface of the base adapted to provide support for a beverage container thereon and insulation from the underlying surface. Another particularly favored mode of the device features a sleeve extending from the top surface of the base having an interior cavity adapted for frictional engagement around the exterior of a beverage container. The sleeve provides insulation for the sides of the beverage container while concurrently securing the beverage container to the device itself. Preferably the sleeve is made from an elastic material such as neoprene used for wet suits or similar insulating material. If elastic material is used, the diameter of the interior cavity would be equal to or slightly less than the diameter of the intended container to thereby provide increased frictional engagement from the compressed sleeve around the container.

Enhancement of the grip of the hand of the user when employing the device to twist off a cap is provided by either surfacing the exterior edge of the base with gnarling or similar surface traits to limit slippage of a gripping hand, or by the provision of an interior wall which rises above the top surface of the base. The interior wall can be employed when a sleeve extends from the top surface of the base, the result being that a hand encircling the device will also encircle the material sleeve over the interior wall. The sleeve being made from fabric or rubber or other synthetic material used for insulation naturally tends not to slip inside of a hand gripping it between the interior wall and the material. Or, both surfacing and the interior wall might be provided for an especially easy to grip without slipping device.

Finally, in another mode of the device, means for releasable engagement of the base to an underlying surface may be provided for additional enhancement. This would be especially attractive when the sleeved version of the base engages a drink on a boat or moving vehicle. The sleeve will retain the container engaged with the base. On the bottom surface of the base is positioned one or a plurality of means for removable engagement to the underlying surface in the form of magnets or hook and loop fabric. If a magnet is employed, the base will be attracted to ferrous metal surfaces and will not easily slide. If hook and loop fabric is employed and the hook is placed on the bottom surface, it will naturally engage with opposing loop fabric on the underlying surface or in many cases with upholstery, rug, or other fabric which will naturally stick to the hook component of hook and loop fabric.

Accordingly, it is the object of this invention claimed herein to provide a beverage container opener which will easily engage with and open a twist-off bottle cap.

It is another object of this invention to provide such a beverage container opener which will easily engage with and open a conventional lift-off of bottle cap.

It is still another object of this invention such a beverage container opener which will easily engage with and open a pull tab ring on an aluminum can beverage container.

It is yet another object of this invention to provide such a beverage container opener that will engage with and open a plurality of beverage containers with one opener.

It is an additional object of this invention to provide such a beverage container opener that also insulates the beverage container from warm surrounding air and/or a warmer underlying surface.

It is a still a further object of this invention to provide such a beverage container opener which also provides a means of enhanced removable engagement between the underlying surface and the beverage container.

With respect to the above description, before explaining at least one preferred embodiment of the invention in detail, it is to be understood that the invention is not limited in its application to the details of construction and to the arrangement of the components or steps set forth in the following description or illustrated in the drawings. The apparatuses of the invention are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the objects and claims be regarded as including such equivalent construction and methodology insofar as they do not depart from the spirit and scope of the present invention. Further objectives of this invention will be brought out in the following part of the specification, wherein detailed description is for the purpose of fully disclosing the invention without placing limitations thereon.

### BRIEF DESCRIPTION OF THE DRAWING FIGURES

The accompanying drawings which are incorporated in and form a part of this specification illustrate embodiments of the disclosed beverage insulating and opening device and together with the description, serve to explain the principles of the invention.

FIG. 1 is a perspective view of the disclosed device showing the base having an insulating containment sleeve extending from a top surface.

FIG. 2 depicts a mode of the device having a top surface adapted for engagement to the bottom of a beverage container.

FIG. 3 shows a view of the central portion of the base of the device showing a webbed support structure which also forms insulating chambers.

FIG. 4 depicts a view of the bottom surface of the device having all three of the means for opening beverage container closures.

FIG. 5 is a side view of the device of FIG. 1 showing a beverage container engaged in the insulating containment sleeve engaged over a lower portion of a beverage container.

FIG. 6 is a sectional view through FIG. 5 depicting a beverage chamber inside the insulating sleeve and also showing the two cavities communicating with the bottom surface of the base.

FIG. 7 depicts a bottom view of the device with a bottle cap engaged in one cavity adapted to twist it.

FIG. 8 shows a bottom view of the device having a bottle cap engaged in the cavity dimensioned to lift it from the top of a compressed engagement with a bottle.

FIG. 9 is a sectional view of FIG. 7.

FIG. 10 is a sectional view of FIG. 8.

FIG. 11 depicts the device lifting a pull tab from a conventional beverage can.

### DETAILED DESCRIPTION OF PREFERRED EMBODIMENTS OF THE DISCLOSED DEVICE

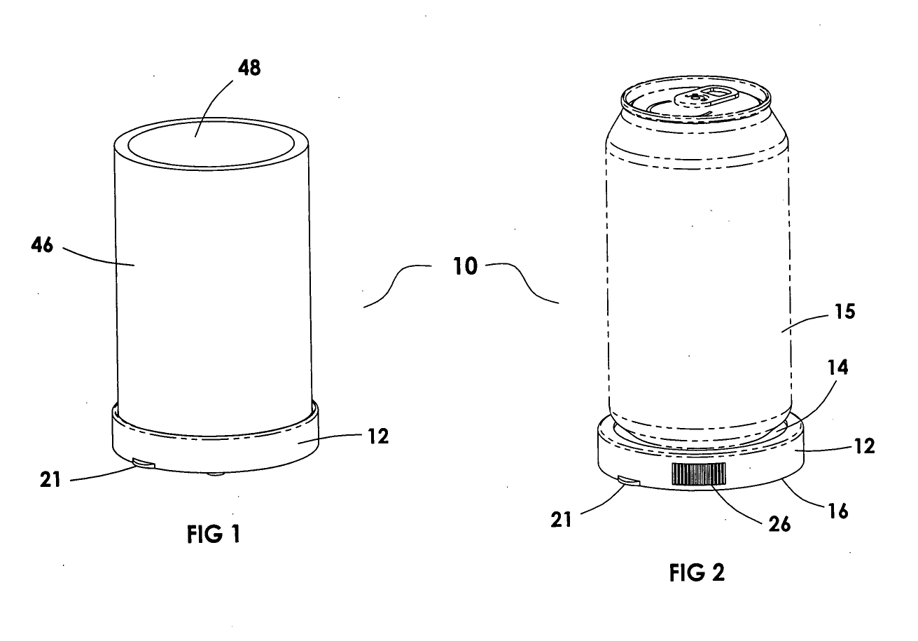

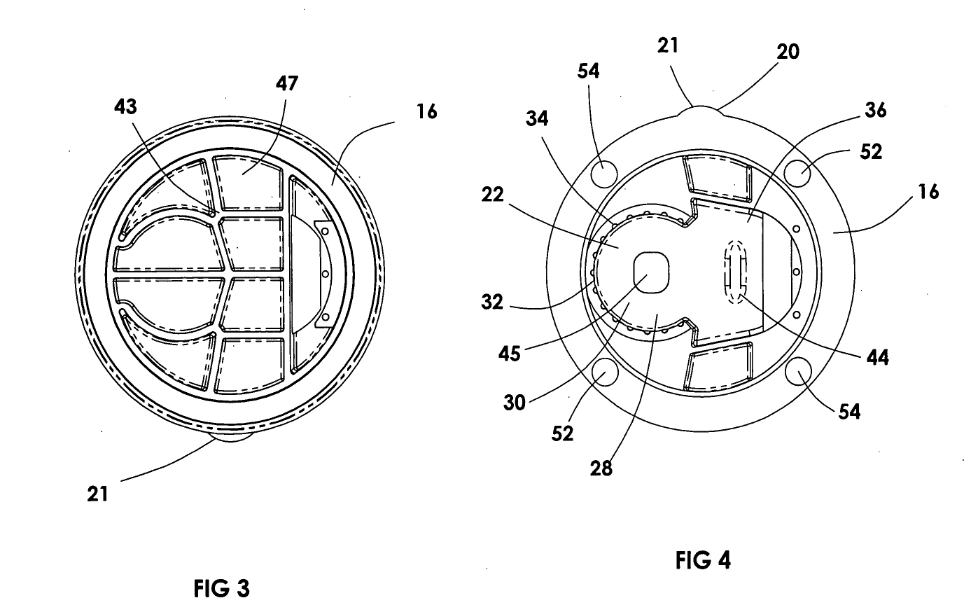

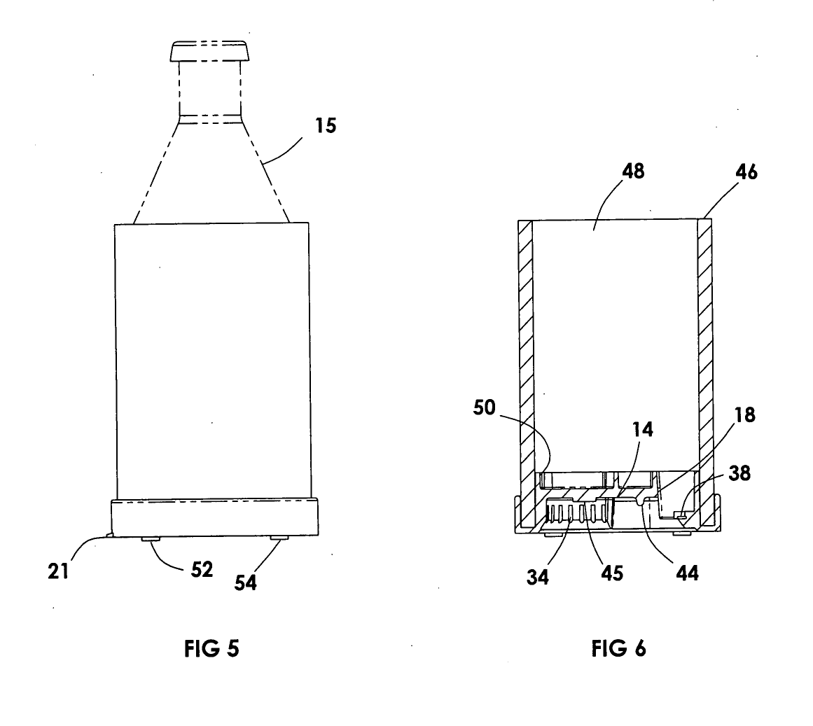

With reference to the drawings shown in FIGS. 1-11, various preferred modes and components of the disclosed device 10 are depicted. In its simplest form shown in FIG. 2, the device 10, has a base 12 having a top surface 14 adapted to support a beverage container 15 thereon and a bottom surface 16 adapted to support the device 10 on an underlying support surface.

At least one means of engagement with at least one type of beverage container closure is provided and in a particularly preferred mode of the device 10, a plurality or three means of engagement with three different types of beverage container closures are provided. As noted, each means of engagement to a respective beverage container closure provides increased mechanical advantage in the form of torque and leverage to open the respective closure from that which would be available if the user simply employed their bare hand.

As depicted in FIG. 2, the basic mode of the device 10 features a base 12 having a top surface 14 adapted to provide a support for the beverage container 15 above and spaced from the underlying surface by a central portion 18 of the base 12. Formed on a bottom surface 16 as best shown in FIG. 4, is at least one, and preferably a plurality of means for opening beverage container closures from group of such closure openers including a pull tap lifting component 20, a bottle cap twisting component 22, and a bottle cap lifting component 24.

The perimeter edge of the base can be knurled 26 or otherwise surfaced as a means to enhance frictional engagement of a hand gripping the base 12 thereby providing increased torque before the hand slips when used to open a twist-off bottle cap. This increased torque is naturally provided by the larger circumference of the perimeter of the base 12 and the prevention of hand slippage thereon.

The pull tab lifting component 20 is provided by a ledge 21 extending beyond the outside circumference of the base 12. The ledge 21 in the current preferred mode of the device 10 is formed by a projection from the base of a thickness adapted to easily slide under a pull tab of a conventional beverage container employing pull tabs. The ledge 21 it has been found from experimentation is best if tapered from a thinner distal edge to a thicker rear edge at the point of engagement to the base 12. In operation once the ledge 21 is engaged under a pull tab, pulling the base 12 upward from the edge opposite the ledge 21 will force a pull tab to an upward angle thereby saving many a fingernail.

The bottle cap twisting component 22 is provided by a first cavity 28 formed onto the bottom surface 16 of the base 12. This first cavity 28 has a top surface 30 and a side surface 32 defining a diameter adapted to frictionally engage around the perimeter edge of a twist off bottle cap. Corrugating 34 or other means for enhancing engagement to the side surface of a conventional twist-off bottle cap is best provided in the side surface 32 to provides a means for enhanced engagement of the perimeter edge to a twist-off bottle cap inserted in the first cavity 28. In use, the user can easily twist off a bottle cap with the increased torque provided by the diameter of the base 12 being larger than the diameter of the bottle cap.

The bottle cap lifting component 24 provides a means for disengagement of compressedly engaged bottle caps and is formed by a second cavity 36 on bottom surface 16 of the base 12. This second cavity 36 while not round has a perimeter side edge 40 on one side which engages adjacent to the exterior edge of a non-twist compressedly engaged bottle cap inserted in the second cavity to thereby provide a means of registration for such a bottle cap in the second cavity 36 to line it up with one edge of the bottle cap under an overhang 38 extending from a portion of the side edge 40 defining the dimension of the second cavity 36. This overhang 38 is spaced a sufficient distance from the top wall 42 of the second cavity 36 to allow a leading edge of a non-twist bottle cap inserted into the second cavity 36 to slide under the overhang 38. Once so inserted the user, much like removing a pull tab with the ledge 21, will remove the bottle cap by lifting the opposite side of the base 12 from the side in which the overhang is positioned in the second cavity 36.

Also, in a preferred mode of the device a vertical fulcrum 44 projects from the top wall 42 of the second cavity 36 and is positioned a distance from the side edge 40 where the overhang 38 projects, to place the fulcrum 44 in a center portion of an inserted cap. When the overhang 38 is thereafter lifted by lifting the base 12, this fulcrum 44 provides a means for focusing force to cause the cap to bend along a line running through a middle portion of the top of the cap, thereby allowing for an easier break of the seal of the cap to the bottle.

In addition to providing one or a plurality of different means for engagement and opening of beverage container closures, the device 10 also provides means for insulation from the support surface on which the beverage container sits and means for insulation from the surrounding atmosphere when an insulating sleeve extends from the top surface 14 of the base 12. In insulating the container from the underlying surface the device 10 provides a webbed support structure 43 which also forms insulating chambers 47. In a favored mode of the device 10 the sleeve 46 also has a container cavity 48 sized to frictionally engage the beverage container therein engaged and both hold the container to the base 12 and insulate the beverage container from both the surrounding atmosphere and the underlying surface on which the base 12 rests.

Because the sleeve 46 also engages the exterior of the beverage container and holds it to the base 12, the addition of an optional means for removable engagement with the underlying surface helps provide a stable mount for the beverage container left in the device. This would be an especially attractive characteristic when drinking from such containers in moving vehicles and boats. Preferably the sleeve 46 is made from an elastic material such as neoprene used for wet suits or similar insulating material. When such an elastic material is employed, the diameter of the container cavity 48 would be sized substantially equal to or slightly less than the diameter of the intended container to thereby provide means for increased frictional engagement with the container from the compressed sleeve 46 around the container.

As noted, enhancement of the grip of the hand of the user when employing the device 10 to twist off a cap may be provided by surfacing the exterior edge of the base 12. In the mode of the device 10 employing the sleeve 46, another means to prevent slippage of the hand is provided in a preferred mode of the device 10 or by an interior wall 50 engaged to the base 12 and rising above the top surface 14. With the sleeve being made from fabric or rubber or other synthetic material used for insulation, such materially inherently tends not to slip inside of a hand gripping it. The provision of the interior wall 50 allows the user to compressedly grip the exterior of the sleeve 46 which is sandwiched between the hand and the interior wall 50 thereby increasing traction of the hand during twisting.

In another preferred mode of the device employable with any of the herein described configurations, a means for releasable engagement of the base to an underlying surface may be provided to maintain the base 12 and an engaged container 15 in place. This would be especially attractive when the sleeved version of the base 12 is engaged with a beverage container on a boat or moving vehicle. The sleeve 46 retains the beverage container 15 with the base 12 while on the bottom surface 16 of the base 12 is positioned one or a plurality of means for removable engagement to the underlying surface. Such means for removable engagement of the base 12 to the underlying surface can be provided from any number of means for releasable attachment with the current preferred devices being one or a combination of magnets 52 and hook and loop fabric 54 either of which will help maintain the base 12 and the engaged beverage container 15 to an underlying surface. For an especially useful mode of the device 10 both can be provided thereby allowing the device to engage with ferrous surfaces or carpeted or upholstered surfaces and resist sliding during acceleration or bumps.

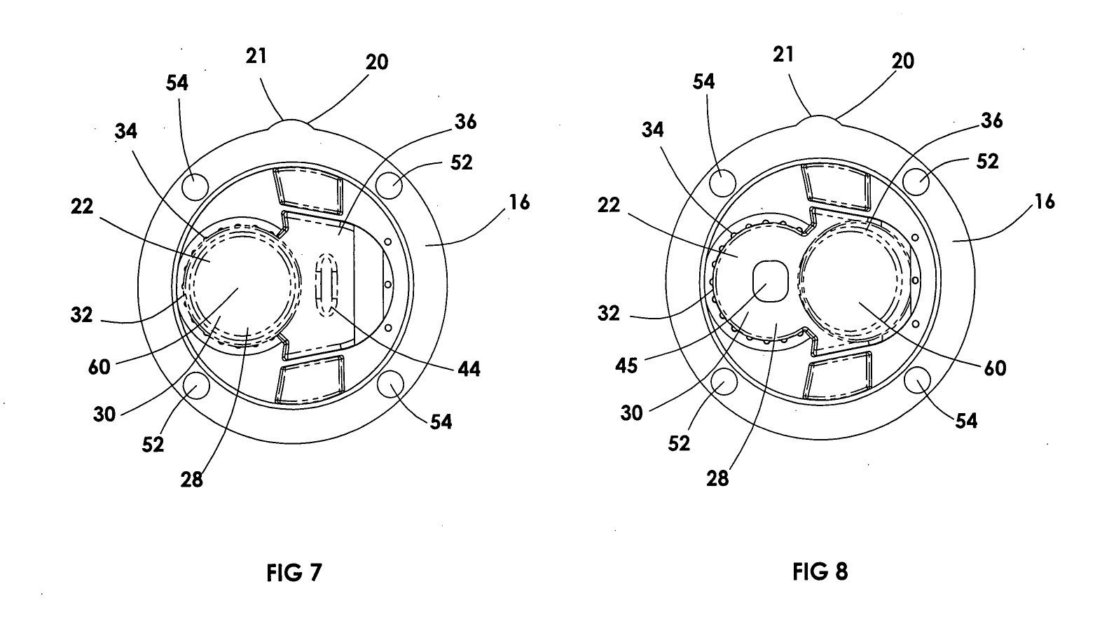

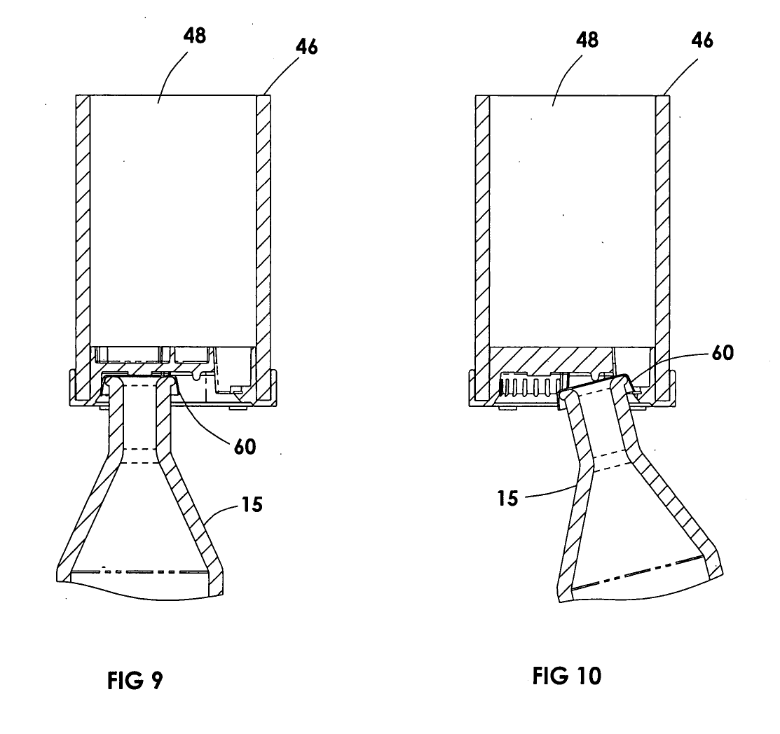

FIGS. 7 and 9 depict a bottom view and side view of the device 10 with a bottle cap engaged in one cavity adapted to twist it. The bottle cap twisting component 22 is provided in the first cavity 28 formed onto the bottom surface 16 of the base 12. As noted, the first cavity 28 has a top surface 30 and a side surface 32 defining a diameter adapted to frictionally engage around the perimeter edge of a twist off bottle cap. Corrugating 34 or other means for enhancing engagement to the side surface of a conventional twist off bottle cap is best provided in the side surface 32 to provide means for enhanced engagement of the perimeter edge to a twist-off bottle cap inserted in the first cavity 28. A stop 45, while not necessary for the device to perform the task herein, is desirable in that through experimentation it has been found that preventing the bottle cap 60 from contacting the corrugating 34 on the surface in an excessively tight fit especially with a strong user will allow the cap to drop out once removed. In use, the user can easily twist off a bottle cap with the increased torque provided by the diameter of the base 12 being larger than the diameter of the bottle cap which will drop from its frictional engagement in the device 10. As such, the stop 45 provides a means to maintain the cap 60 from engaging the side surface 32 with excessive force.

FIGS. 8 and 10 show a bottom view and side view of the device 10 wherein a bottle cap 60 is engaged in the second cavity 36 which is dimensioned to lift it from the top of a compressed engagement with a bottle. As noted, this second cavity 36 has a perimeter side edge 40 on one side to engage adjacent to the exterior edge of a non-twist compressedly engaged bottle cap 60 inserted in the second cavity 36, to thereby provide a means of registration for such a bottle cap in the second cavity 36. A small relief is also shown in the second cavity 36 to allow for easy angling of the cap 60 under the overhang 38 in a current preferred mode. This relief can extend through to the top surface as a passage to provide a vent for air pressure that can build up during insertion of a container into the tight fitting sleeve 46 when employed. This registered engagement of an inserted cap as shown lines one edge of the bottle cap under an overhang 38 extending from a portion of the side edge 40 which defines the dimension of the second cavity 36. The ledge 21 will remove the bottle cap by lifting the opposite side of the base 12 from the side in which the overhang is positioned in the second cavity 36. As noted, in a preferred mode of the device a vertical fulcrum 44 projects from the top wall 42 to bend the top of the cap and reduce the force required to remove it.

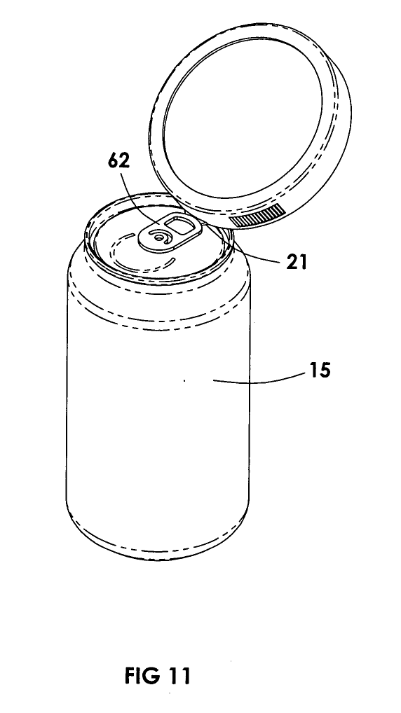

Finally, FIG. 11 depicts the device 10 lifting a pull tab from a conventional beverage can employing the ledge 21 extending from the circumference of the base 12. The ledge 21 allows easy prying of the pull tab 62 from its parallel position in relation to the top of the can to an upright position wherein it can be more easily pulled by a finger.

Although the invention has been described with respect to particular embodiments thereof, it should be realized that various changes and modifications may be made therein without departing from the spirit and scope of the invention. While the invention as shown in the drawings and described in detail herein discloses arrangements of elements of particular construction and configuration for illustrating preferred embodiments of structure and method of operation of the present invention, it is to be understood, however, that elements of different construction and configuration and other arrangements thereof, other than those illustrated and described, may be employed in accordance with the spirit of this invention. Further some elements may be used in combination without others and still yield an improvement in the art. Any and all such changes, alterations and modifications as would occur to those skilled in the art are considered to be within the scope of this invention as broadly defined in the appended claims.

Further, the purpose of the attached abstract is to enable the U.S. Patent and Trademark Office and the public generally, and especially the scientists, engineers and practitioners in the art who are not familiar with patent or legal terms or phraseology to determine quickly from a cursory inspection the nature and essence of the technical disclosure of the application. The abstract is neither intended to define the invention of the application which is measured by the claims, nor is it intended to be limiting as to the scope of the invention in any way.

What is claimed is:

1. A beverage container receptacle and opening apparatus comprising:
a base, said base having a top surface, a bottom surface and a side surface defining a perimeter edge;
said top surface adapted to support a beverage container thereon;
said bottom surface adapted for positioning said base on an underlying support surface with said top surface substantially parallel to said underlying surface; and
said base having one or a plurality of means for opening said beverage container, from a group of means for opening beverage containers, consisting of, a means for twisting off a bottle cap, a means for prying off a bottle cap, and a means for prying a pull tab to an inclined position, positioned thereon.

2. The beverage container receptacle and opening apparatus of claim 1 additionally comprising:
said base having cavities formed between said top surface and said bottom surface, said cavities providing means to insulate said beverage container situated on said top surface, from said underlying surface.

3. The beverage container receptacle and opening apparatus of claim 1 additionally comprising:
a flexible sleeve engaged to said base adjacent to said perimeter edge;
said sleeve having an interior surface and an exterior surface;
said interior surface defining a beverage cavity;
said beverage cavity adapted to allow insertion of said beverage container therein; and
said sleeve providing means for insulation of said beverage container from the atmosphere.

4. The beverage container receptacle and opening apparatus of claim 2 additionally comprising:
a flexible sleeve engaged to said base adjacent to said perimeter edge;
said sleeve having an interior surface and an exterior surface;
said interior surface defining a beverage cavity;
said beverage cavity adapted to allow insertion of said beverage container therein; and
said sleeve providing means for insulation of said beverage container from the atmosphere.

5. The beverage container receptacle and opening apparatus of claim 1 wherein:
said means for twisting off a bottle cap is formed by a cavity depending into said bottom surface, said cavity having a sidewall adapted to engage with the perimeter edge of said bottle cap when inserted therein;
said means for prying off a bottle cap is formed by a second cavity depending into said bottom surface defined by a second sidewall and a ledge extending from said sidewall adapted to engage under a bottle cap inserted in said second cavity; and
said means for prying a pull tab to an inclined position is formed by a tab extending from said perimeter edge.

6. The beverage container receptacle and opening apparatus of claim 2 wherein:
said means for twisting off a bottle cap is formed by a cavity depending into said bottom surface, said cavity having a sidewall adapted to engage with the perimeter edge of said bottle cap when inserted therein;
said means for prying off a bottle cap is formed by a second cavity depending into said bottom surface defined by a second sidewall and a ledge extending from said sidewall adapted to engage under a bottle cap inserted in said second cavity; and
said means for prying a pull tab to an inclined position is formed by a tab extending from said perimeter edge.

7. The beverage container receptacle and opening apparatus of claim 2 wherein:
said means for twisting off a bottle cap is formed by a cavity depending into said bottom surface, said cavity having a sidewall adapted to engage with the perimeter edge of said bottle cap when inserted therein;
said means for prying off a bottle cap is formed by a second cavity depending into said bottom surface defined by a second sidewall and a ledge extending from said sidewall adapted to engage under a bottle cap inserted in said second cavity; and
said means for prying a pull tab to an inclined position is formed by a tab extending from said perimeter edge.

8. The beverage container receptacle and opening apparatus of claim 1, additionally comprising:
means for removable engagement to said underlying surface positioned on said bottom surface.

9. The beverage container receptacle and opening apparatus of claim 2, additionally comprising:
means for removable engagement to said underlying surface positioned on said bottom surface.

10. The beverage container receptacle and opening apparatus of claim 3, additionally comprising:
means for removable engagement to said underlying surface positioned on said bottom surface.

11. The beverage container receptacle and opening apparatus of claim 5, additionally comprising:
means for removable engagement to said underlying surface positioned on said bottom surface.

12. The beverage container receptacle and opening apparatus of claim 6, additionally comprising:
means for removable engagement to said underlying surface positioned on said bottom surface.

13. The beverage container receptacle and opening apparatus of claim 7, additionally comprising:
means for removable engagement to said underlying surface positioned on said bottom surface.

14. The beverage container receptacle and opening apparatus of claim 1, additionally comprising:
means to reduce slippage of a hand gripping said base about said perimeter edge and twisting said base.

15. The beverage container receptacle and opening apparatus of claim 2, additionally comprising:
means to reduce slippage of a hand gripping said base about said perimeter edge and twisting said base.

16. The beverage container receptacle and opening apparatus of claim 3, additionally comprising:
means to reduce slippage of a hand gripping said base about said perimeter edge and twisting said base.

17. A beverage container receptacle and opening apparatus comprising:
a base, said base having a top surface, a bottom surface and a side surface defining a perimeter edge;
said top surface adapted to support a beverage container thereon;
said bottom surface adapted for positioning said base on an underlying support surface; and
a twist-off bottle cap remover formed in said bottom surface formed by a cavity depending into said bottom surface, said cavity having a sidewall adapted to engage with the perimeter edge of a twist-off bottle cap when inserted therein;
a pry-off a bottle cap remover formed in said bottom surface formed by a second cavity depending into said bottom surface and a ledge extending from a sidewall defining said second cavity, said ledge adapted to engage under a pry-off bottle cap inserted into said second cavity; and
a pull tab prying component for prying a pull tab engaged with the top of a beverage container, to an inclined position, said pull tab prying component formed by a tab extending from said perimeter edge.

18. The beverage container receptacle and opening apparatus of claim 17 additionally comprising:
a flexible sleeve engaged to said base adjacent to said perimeter edge said sleeve having an interior surface defining a beverage cavity and having an exterior surface;
said beverage cavity adapted to allow insertion of said beverage container therein; and
said sleeve providing means for insulation of said beverage container from the atmosphere.

19. The beverage container receptacle and opening apparatus of claim 17 additionally comprising:
said sleeve formed of elastic material;
said beverage cavity sized equal to or smaller than said beverage container;
means for removable engagement of said bottom surface to said underlying surface; and
whereby said beverage container engaged in said sleeve will remain in place on said underlying surface when said underlying surface moves.

20. The beverage container receptacle and opening apparatus of claim 19 wherein said means for removable engagement of said bottom surface to said underlying surface includes one or a combination of a magnet and hook and loop style fabric.
